(19) United States
(12) Patent Application Publication
(10) Pub. No.: US 2006/0071564 A1
(43) Pub. Date: Apr. 6, 2006

(54) Apparatus and methods of retaining a stator within a housing of an electric machine

(76) Inventor: William P. Stewart, Saint Peters, MO (US)

Correspondence Address: HARNESS, DICKEY, & PIERCE, P.L.C, 7700 BONHOMME, STE 400, ST. LOUIS, MO, 63105, US

(21) Appl. No.: 10/958,196

(22) Filed: Oct. 4, 2004

(51) Int. Cl. H02K 5/00

(52) U.S. Cl. 310/89

(57) ABSTRACT

An electric machine includes a housing defining a stop therein and an end shield coupled to the housing. The machine also includes a non-segmented stator or a segmented stator. In either case, the stator is captured between the end shield and the stop within the housing. The stator includes a first end portion abutting against the stop. The stop is configured to maintain contact with the stator even during operation of the machine to thereby restrain movement of the stator relative to the housing.

### FIELD

The present invention generally relates to electric machines, and more particularly (but not exclusively) to apparatus and methods for retaining a stator within a housing of an electric machine independent of mechanical fasteners.

### BACKGROUND

In electric machine applications, the stator's position must be maintained both axially and radially relative to the housing. To accomplish this feat, stators are commonly retained in a housing with mechanical fasteners and/or through a circumferential interference fit between the stator and the housing. For example, some applications capture the stator between two end shields, which, are, in turn, bolted to one another. This bolting, however, usually requires a clearance fit to the housing, which can reduce the thermal efficiency of the machine.

The inventor hereof has observed that maintaining a circumferential interference fit between a stator and a housing can be difficult across the large operating temperature ranges of electric machines especially when the housing and stator have significantly different coefficients of thermal expansion. The inventor has recognized that modifying this interference fit between the stator and the housing can result in either high stress in the housing at low temperatures, or a loss of contact and thus interference fit between the stator and housing at elevated temperatures.

### SUMMARY

In one implementation, an electric machine includes a housing defining a stop therein and an end shield coupled to the housing. The machine also includes a non-segmented stator or a segmented stator. In either case, the stator is captured between the end shield and the stop within the housing. The stator includes a first end portion abutting against the stop. The stop is configured to maintain contact with the stator even during operation of the machine to thereby restrain movement of the stator relative to the housing.

In another implementation, an electric machine includes a housing defining an internal shoulder. The machine also includes an end shield coupled to the housing through an interference fit formed between the end shield and the housing. The end shield and the housing have coefficients of thermal expansion such that the interference fit is maintained across an operating temperature range of the machine. The machine further includes a non-segmented stator or segmented stator. In either case, the stator is captured between the end shield and the internal shoulder within the housing. The stator includes a first end portion abutting against the internal shoulder and a second end portion abutting against the end shield. The internal shoulder and the end shield restrain movement of the stator relative to the housing independent of mechanical fasteners.

In another aspect, the present invention provides a method of securing a stator within a housing of an electric machine independent of mechanical fasteners. The stator may be a segmented stator or a non-segmented stator. In one implementation, the method generally includes positioning the stator within the housing to abut against an internal stop defined within the housing, and coupling an end shield to the housing such that a first end portion of the stator abuts against the internal stop and a second end portion of the stator abuts against the end shield. The internal stop and the end shield restrain movement of the stator relative to the housing.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is an exploded perspective view showing a segmented stator and end shield aligned for positioning within a housing according to an exemplary embodiment of the invention;

FIG. 2 is an exploded view showing the segmented stator and end shield aligned for positioning within the housing (cross-section) shown in FIG. 1;

FIG. 3 is a view of the segmented stator captured between the end shield and an internal stop within the housing (cross-section) shown in FIGS. 1 and 2;

FIG. 4 is an inner perspective view of the housing shown in FIG. 1;

FIG. 5 is an inner view of the housing shown in FIG. 4;

FIG. 6 is an exploded perspective view showing a non-segmented stator and end shield aligned for positioning with a housing according to an exemplary embodiment of the invention;

FIG. 7 is an exploded view showing the non-segmented stator and end shield aligned for positioning within the housing (cross-section) shown in FIG. 6; and

FIG. 8 is a view of the non-segmented stator captured between the end shield and an internal stop within the housing (cross-section) shown in FIGS. 6 and 7.

Corresponding reference numerals indicate corresponding parts throughout the several views of the drawings.

### DETAILED DESCRIPTION OF THE EXEMPLARY EMBODIMENTS

The following description of the exemplary embodiments is merely exemplary in nature and is in no way intended to limit the invention, its application, or uses.

An electric machine according to one aspect of the invention includes a housing defining a stop therein and an end shield coupled to the housing. The machine also includes a non-segmented stator or a segmented stator. In either case, the stator is captured between the end shield and the stop within the housing. The stator includes a first end portion abutting against the stop. The stop is configured to maintain contact with the stator even during operation of the machine to thereby restrain movement of the stator relative to the housing. In yet other aspects, the invention provides housings that define internal stops, stators, stator segments, end shields, and combinations thereof. Further aspects of the invention include electric machines, electric motors, electric superchargers, vehicles (e.g., automobiles, etc.), switched reluctance motors, brushless permanent magnet (BPM) motors, induction motors, and electric generators that include housings, stators, stator segments, and/or end shields of the present invention.

Accordingly, various implementations of the present invention allow electric machine manufacture to be streamlined by eliminating the need for mechanical fasteners (e.g., bolts for the stator and/or end shield, etc.) to retain the stator within the housing thereby reducing the number of discrete operations required to assembly an electric machine. By capturing the stator between the end shield and a stop within the housing, the stator's position can be retained even without a circumferential interference fit between the stator and the housing. This, in turn, enables greater control of concentricity between the stator, end shield, and housing than applications in which stator position is maintained solely by a circumferential interference fit between the stator and the housing and thus influenced by temperature.

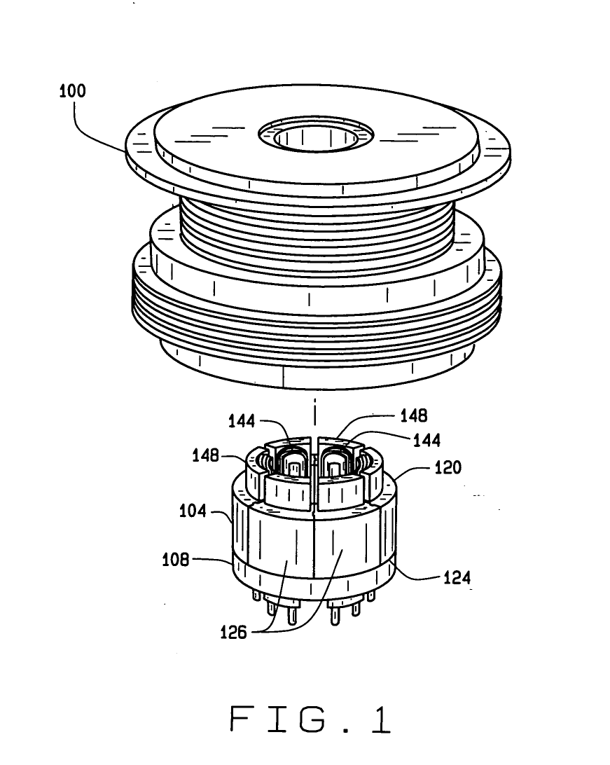

FIGS. 1 through 5 illustrate an exemplary housing 100 in accordance with the principles of this invention. As shown, the housing 100 is sized to receive therein a stator 104 and an end shield 108. The housing 100 defines an internal stop 116 configured to maintain contact with the stator 104 even during operation of the machine to thereby restrain movement of the stator 104 relative to the housing 100. In the illustrated embodiment of FIGS. 1 through 5, the stop 116 comprises an internal shoulder configured to abut against an end portion 120 of the stator 104.

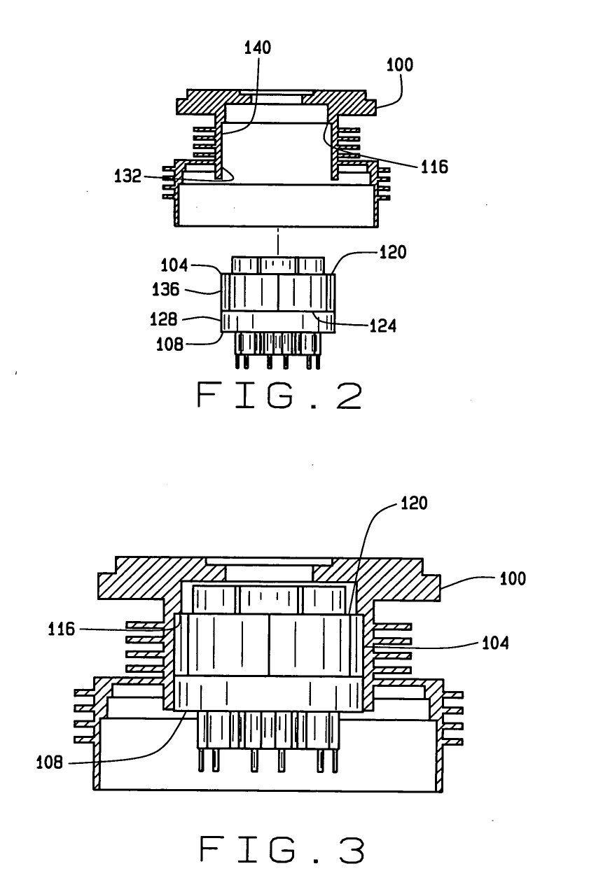

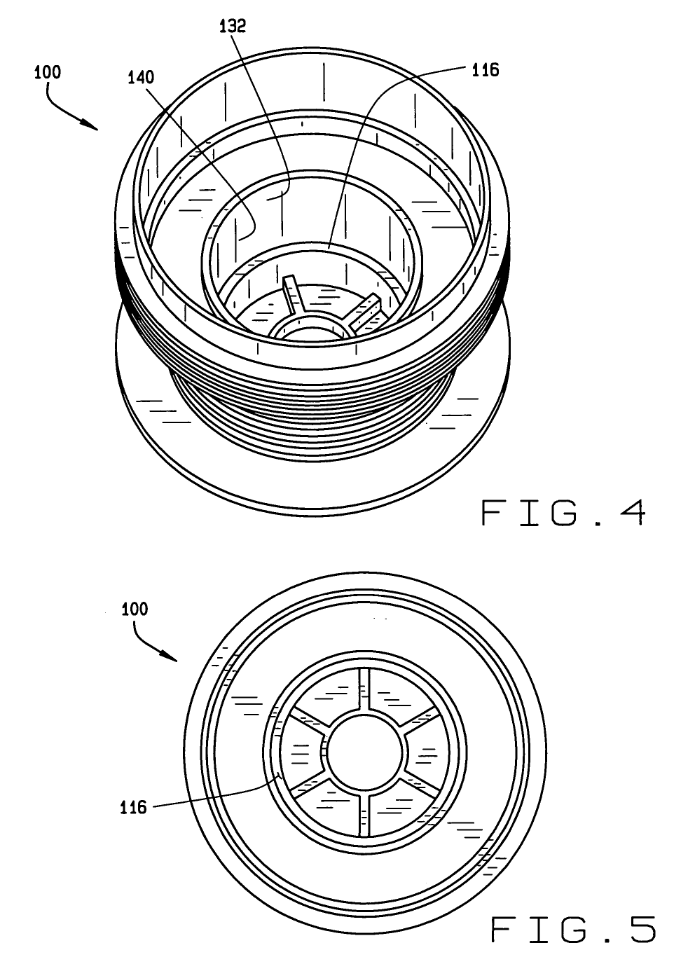

With further reference to FIGS. 1 and 2, the stator 104 is shown positioned on the end shield 108 and aligned for positioning with the housing 100. FIG. 3 illustrates the stator 104 and end shield 108 positioned within the housing 100 such that the end portions 120 and 124 of each stator segment 126 respectively abuts against the internal stop 116 and end shield 108. In this exemplary manner, the stator 104 can be captured between the end shield 108 and the internal stop 116 independent of mechanical fasteners, such as bolts.

While FIGS. 1 and 2 illustrate the stator 104 being positioned on the end shield 108 before they are positioned within the housing 100, such is not required. Alternative implementations can include positioning the stator 104 within the housing, and then positioning the end shield 108 within the housing 100 as a separate component in a discrete operation. In either case, either or both the stator 104 and/or the housing 100 can be moved so as to position the stator 104 within the housing 100 until the end portions 120 of the stator segments 126 abut against the internal stop 116 within the housing 100. At which point, the stop 116 inhibits continued movement of the stator 104 into the housing 100.

In preferred implementations, the end shield 108 is coupled to the housing 100 through an interference fit formed between a sidewall 128 of the end shield 108 and a surface 132 of the housing 100. With this interference fit, the end shield 108 can thus be engaged to and retained within the housing 100 independent of mechanical fasteners.

A description will now be provided of an exemplary method for forming the interference fit between the end shield's sidewall 128 and the housing's surface 132. First, the housing 100 can be heated (e.g., induction heated, etc.) to thermally expand the housing 100. The end shield 108 and/or housing 100 can then be moved relative to one another so as to position the end shield 108 within the thermally expanded housing 100. That is, the end shield 108 can be moved towards the housing 100 as the housing 100 remains stationary, or the housing 100 can be moved towards the end shield 108 as the end shield 108 remains stationary, or both the end shield 108 and the housing 100 can be moved towards each other. The housing 100 is allowed to cool and thermally contract against the end shield's sidewall 128, thereby forming an interference fit between the housing 100 and the end shield 108. Allowing the housing 100 to cool can include either or both passively allowing the housing 100 to cool and/or actively cooling the housing 100.

Alternatively, other implementations can form the interference fit by thermally contracting the end shield (e.g., by actively cooling the end shield), moving the end shield and/or housing relative to one another so as to position the thermally contracted end shield within the housing, and allowing the end shield to thermally expand against the housing (e.g., by actively heating and/or passively allowing the end shield to return to ambient temperate). In further implementations, the interference fit between the housing and the end shield can be formed by using other suitable methods, such as axial press fitting and thermally conductive adhesives.

A wide range of materials can be used for the housing 100, stator 104, and end shield 108. In preferred implementations, the housing 100 and the end shield 108 are formed from suitable materials so that the housing 100 and end shield 108 have coefficients of thermal expansion for maintaining the interference fit therebetween across an operating temperature range of the machine. This, in turn, allows the stator's 104 position to be retained between the internal stop 116 and the end shield 108 without being influenced by temperature (or least with little influence from temperature).

In one exemplary embodiment, the housing 100 and end shield 108 are formed of the same material, such as aluminum, among other suitable materials. In which case, the housing 100 and end shield 108 can have about equal coefficients of thermal expansion and thus expand at about the same rate. Alternatively, the housing 100 and end shield 108 can be formed from different materials yet still have coefficients of thermal expansion for maintaining the interference fit across an operating temperature range of the machine.

Regarding the material(s) used for the stator 104, the stator 104 can be formed from the same material(s) as either or both the housing 100 and the end shield 108. In various implementations, however, the stator 104 is formed from a different material that has a lower coefficient of thermal expansion than that used for either the housing 100 and/or end shield 108. For example, one exemplary embodiment includes a steel stator, an aluminum end shield, and an aluminum housing.

In addition to being captured between the end shield 108 and the stop 116 within the housing 100, various implementations can include the stator 104 and the housing 100 being configured so that a circumferential interference fit is formed therebetween, such as between the stator sidewall 136 and the housing surface 140. This circumferential interference fit can help further secure the stator 104 within the housing 100. In such implementations, this circumferential interference fit may be maintained at all but the highest operating temperatures of the machine. But even if the circumferential interference fit is lost, for example, due to a greater rate of thermal expansion of the housing 100 than the stator 104, the stator 104 can remain captured between the stop 116 and end shield 108.

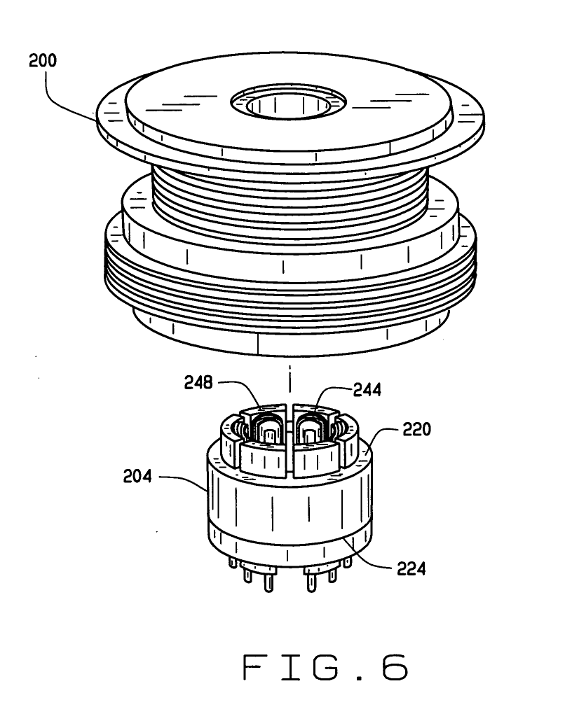

In FIGS. 1 through 3, the circumferentially segmented stator 104 includes six stator segments 126. Alternative embodiments, however, can include segmented stators having more or less than six stator segments depending on the particular application. Indeed, some embodiments include a non-segmented or full round stator. For example, FIGS. 6 through 8 illustrate an exemplary housing 200 that includes an internal stop 216. The stop 216 is configured to maintain contact with a non-segmented stator 204 to restrain movement of the stator 204 relative to the housing 200.

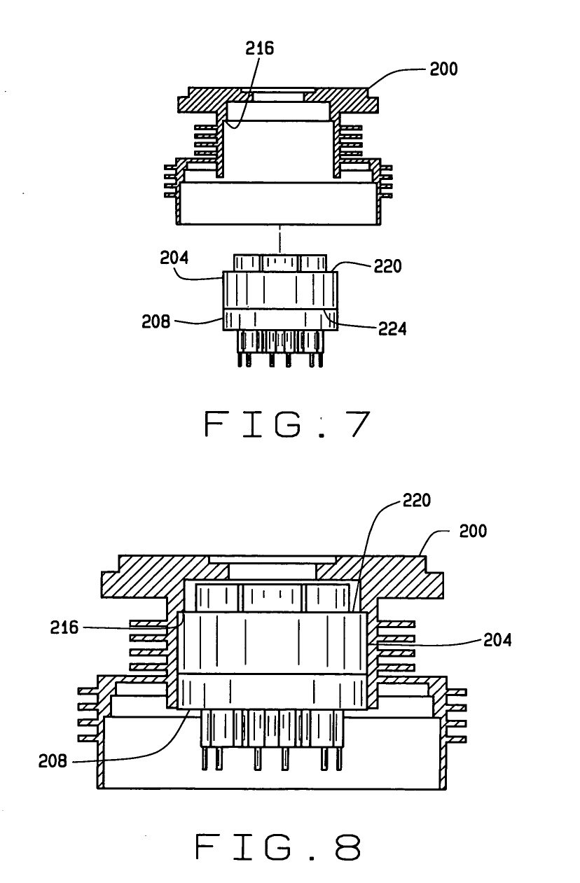

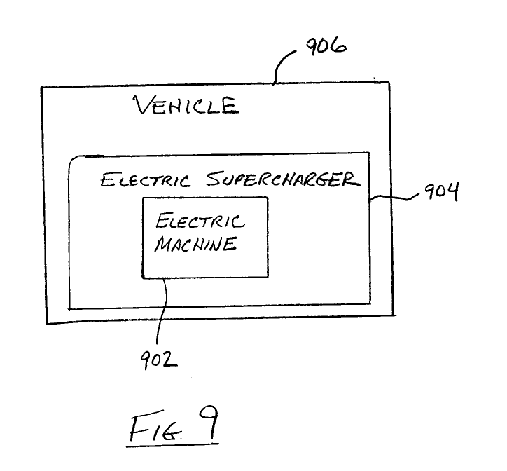

With further reference to FIGS. 6 and 7, the stator 204 is shown positioned on the end shield 208 and aligned for positioning with the housing 200. FIG. 8 illustrates the stator 204 and end shield 208 positioned within the housing 200 such that the stator's end portions 220 and 224 respectively abut against the internal stop 216 and end shield 208. In this exemplary manner, the stator 204 can be captured between the end shield 208 and the internal stop 216 independent of mechanical fasteners, such as bolts.

For purposes of illustration only, FIGS. 1-3 and 6-8 also show the stator windings 144, 244 and end caps 148, 248 coupled to the stator 104, 204. Aspects of the invention, however, are applicable to any suitable number, size, and type of stator windings and end caps. Accordingly, the present invention should not be limited to the particular configuration of stator windings and end caps shown in the figures.

In another form, the present invention provides methods of securing a stator within a housing of an electric machine independent of mechanical fasteners. The stator may be a segmented stator or a non-segmented stator. In one implementation, the method generally includes positioning a stator within the housing to abut against an internal stop defined within the housing, and coupling an end shield to the housing such that a first end portion of the stator abuts against the internal stop and a second end portion of the stator abuts against the end shield. The internal stop and the end shield restrain movement of the stator relative to the housing.

In at least one implementation, the end shield can be coupled to the housing by forming an interference fit between the end shield and the housing. In preferred implementations, the end shield and the housing have coefficients of thermal expansion (e.g., about equal coefficients of thermal expansion) such that the interference fit is maintained across an operating temperature range of the machine.

By way of example only, various implementations form the interference fit by heating the housing to thermally expand the housing, moving the end shield and/or housing to position the end shield within the thermally expanded housing, and then allowing the housing to cool and thermally contract against the end shield. Alternatively, other implementations can form the interference fit by cooling the end shield to thermally contract the end shield, moving the end shield and/or housing to position the thermally contracted end shield within the housing, and then allowing the end shield to warm to ambient temperate and thermally expand against the housing. In further implementations, the interference fit between the housing and the end shield can be formed by using other suitable methods.

In those implementations in which the stator is segmented, the method can include positioning each stator segment within the housing such that a first end portion of each stator segment abuts against the internal stop and a second end portion of each stator segment abuts against the end shield.

Accordingly, various implementations of the present invention allow electric machine manufacture to be streamlined by eliminating the need for mechanical fasteners for retaining the stator within the housing and by reducing the number of discrete operations required to assemble an electric machine. By capturing the stator between the end shield and stop within the housing, the stator's position can be retained even without a circumferential interference fit between the stator and the housing. This, in turn, enables greater control of concentricity between the stator, end shield, and housing than applications in which stator retention is maintained solely by a circumferential interference fit between the stator and the housing and thus can be influenced by temperature. This also helps eliminate the build-up in axial direction, which otherwise can affect bearing-to-bearing dimension. Further, by maintaining physical contact between the stator and the internal shoulder within the housing, various implementations maintain the stator's thermal path to the outside environment via the housing, which can be important during peak machine operation.

Various aspects of the present invention can be used in a wide range of electric machines, electric motors, electric superchargers, switched reluctance motors, brushless permanent magnet (BPM) motors, induction motors, and electric generators. Accordingly, the specific references to electric machine herein should not be construed as limiting the scope of the present invention to only one specific form/type of electric machine.

The description of the invention is merely exemplary in nature and, thus, variations that do not depart from the gist of the invention are intended to be within the scope of the invention. Such variations are not to be regarded as a departure from the spirit and scope of the invention.

1. An electric machine comprising a housing defining a stop therein, an end shield coupled to the housing, and a stator captured between the end shield and the stop within the housing, the stator including a first end portion abutting against the stop and a second portion contacting the end shield, the stop and the end shield configured to maintain contact with the stator even during operation of the machine to thereby restrain movement of the stator relative to the housing.

2. The machine of claim 1, wherein the end shield is coupled to the housing through an interference fit formed between the end shield and the housing.

3. The machine of claim 2, wherein the end shield and the housing have coefficients of thermal expansion such that the interference fit is maintained across an operating temperature range of the machine.

4. The machine of claim 1, wherein the stator is captured between the end shield and the stop without use of mechanical fasteners.

5. The machine of claim 1, wherein the stator includes a second end portion abutting against the end shield.

6. The machine of claim 1, wherein the end shield and the housing have about equal coefficients of thermal expansion.

7. The machine of claim 6, wherein the end shield and housing each comprise the same material.

8. The machine of claim 1, wherein the stator is a segmented stator including a plurality of stator segments, each said stator segment having a first end portion abutting against the stop.

9. The machine of claim 1, wherein each said stator segment includes a second end portion against the end shield.

10. The machine of claim 1, wherein the stator and the housing are configured so as to create a circumferential interference fit therebetween.

11. An electric supercharger comprising the machine of claim 1.

12. A vehicle comprising the electric supercharger of claim 11.

13. An electric machine comprising a housing defining an internal shoulder, an end shield coupled to the housing through an interference fit formed between the end shield and the housing, the end shield and the housing having coefficients of thermal expansion such that the interference fit is maintained across an operating temperature range of the machine, and a stator captured between the end shield and the internal shoulder within the housing, the stator including a first end portion abutting against the internal shoulder and a second end portion abutting against the end shield, the internal shoulder and the end shield restraining movement of the stator relative to the housing independent of mechanical fasteners.

14. The machine of claim 13, wherein the stator is a segmented stator including a plurality of stator segments, each said stator segment having a first end portion abutting against the internal shoulder and a second end portion abutting against the end shield.

15. A method of securing a stator within a housing of an electric machine independent of mechanical fasteners, the method comprising positioning a stator within the housing to abut against an internal stop defined within the housing, and coupling an end shield to the housing such that a first end portion of the stator abuts against the internal stop and a second end portion of the stator abuts against the end shield, the internal stop and the end shield restraining movement of the stator relative to the housing.

16. The method of claim 15, wherein coupling an end shield includes forming an interference fit between the end shield and the housing.

17. The method of claim 16, wherein the end shield and the housing have about equal coefficients of thermal expansion.

18. The method of claim 16, wherein the end shield and the housing have coefficients of thermal expansion such that the interference fit is maintained across an operating temperature range of the machine.

19. The method of claim 15, wherein the stator is a segmented stator including a plurality of stator segments, and wherein the positioning includes positioning each said stator segment within the housing such that a first end portion of each said stator segment abuts against the internal stop and a second end portion of each said stator segment abuts against the end shield.
